(19) United States
(12) Patent Application Publication
(10) Pub. No.: US 2019/0156748 A1
(43) Pub. Date: May 23, 2019

(54) PIXEL DRIVING CIRCUIT, DRIVING METHOD AND DISPLAY PANEL

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Yufeng JIN, Shenzhen, Guangdong (CN)

(21) Appl. No.: 15/742,286

(22) PCT Filed: Dec. 21, 2017
(86) PCT No.: PCT/CN2017/117757

§ 371 Date: Jan. 5, 2018

(30) Foreign Application Priority Data
Nov. 20, 2017 (CN) 201711161347.4

(51) Int. Cl. G09G 3/3258

(52) U.S. Cl. CPC G09G 3/3258; G09G 2300/0819

(57) ABSTRACT

A pixel driving circuit, a driving method and a display panel are provided. The driving circuit includes first switch, second switch and third switch, first capacitor and second capacitor, and light emitting element. A control terminal of first switch is coupling to first control signal, inputting terminal is coupling to data signal, outputting terminal is coupling to first terminal of first capacitor and control terminal of third switch. A control terminal of second switch is coupling to second control signal, inputting terminal is coupling to data signal, outputting terminal is coupling to second terminal of first capacitor and first terminal of second capacitor. An inputting terminal of third switch is coupling to power source positive voltage, outputting terminal is coupling to second terminal of second capacitor and first terminal of light emitting element. A second terminal of light emitting element is electrically connecting power source negative voltage.

### RELATED APPLICATIONS

The present application is a National Phase of International Application Number PCT/CN2017/117757, filed Dec. 21, 2017, and claims the priority of China. Application No. 201711161347.4, filed Nov. 20, 2017.

### FIELD OF THE DISCLOSURE

The disclosure relates to a display technical field, and more particularly to a pixel driving circuit, a driving method and a display panel are provided.

### BACKGROUND

Pixel driving circuit could use for providing driving circuit of display panel. In the display technology field, the currently OLED has numbers of advantageous such like wide color gamut, high contrast, save power, foldable. Therefore, it recognize by consumers and widely use.

For example, the OLED, because of the property of OLED, the driving circuit needs provide accuracy driving voltage. The existing driving circuit of OLED needs more inputting driving voltage to achieve the driving process, and it is not easily control the accuracy of actual driving voltage because of inputting a larger driving voltage, and also cause problem of OLED power consumption.

### SUMMARY

A technical problem to be solved by the disclosure is to provide a pixel driving circuit, a driving method and a display panel, it could solve the problem about the actual driving voltage has lower accuracy because range the inputting driving voltage of pixel driving circuit is too much.

An objective of the disclosure is achieved by following embodiments. In particular, a driving method of pixel driving circuit, the pixel driving circuit comprising a first switch, a second switch and a third switch, a first capacitor and a second capacitor, and a light emitting element; a control terminal of the first switch is coupling to a first control signal, an inputting terminal of the first switch is coupling to a data signal, an outputting terminal of the first switch is coupling to a first terminal of the first capacitor and a control terminal of the third switch; a control terminal of the second switch is coupling to a second control signal, an inputting terminal of the second switch is coupling to the data signal, an outputting terminal of the second switch is coupling to a second terminal of the first capacitor and a first terminal of the second capacitor; an inputting terminal of the third switch is coupling to a power source positive voltage, an outputting terminal of the third switch is coupling to a second terminal of the second capacitor and a first terminal of the light emitting element; a second terminal of the light emitting element is electrically connecting a power source negative voltage; the driving method comprising: in a first stage, the first control signal providing high potential, switching on the first switch, the second control signal providing low potential, switching off the second switch; in a second stage, the first control signal providing low potential, switching off the first switch, the second control signal providing high potential, switching on the second switch; in a third stage, the first control signal providing low potential, switching off the first switch, the second control signal providing low potential, switching off the second switch.

According to another aspect of the disclosure, the disclosure further provides a pixel driving circuit. The driving circuit comprising a first switch, a second switch and a third switch, a first capacitor and a second capacitor, and a light emitting element; a control terminal of the first switch is coupling to a first control signal, an inputting terminal of the first switch is coupling to a data signal, an outputting terminal of the first switch is coupling to a first terminal of the first capacitor and a control terminal of the third switch; a control terminal of the second switch is coupling to a second control signal, an inputting terminal of the second switch is coupling to the data signal, an outputting terminal of the second switch is coupling to a second terminal of the first capacitor and a first terminal of the second capacitor; an inputting terminal of the third switch is coupling to a power source positive voltage, an outputting terminal of the third switch is coupling to a second terminal of the second capacitor and a first terminal of the light emitting element; a second terminal of the light emitting element is electrically connecting a power source negative voltage.

According to vet another aspect of the disclosure, the disclosure further provides a display panel, wherein the display panel comprising a pixel driving circuit; the driving circuit comprising a first switch, a second switch and a third switch, a first capacitor and a second capacitor, and a light emitting element; a control terminal of the first switch is coupling to a first control signal, an inputting terminal of the first switch is coupling to a data signal, an outputting terminal of the first switch is coupling to a first terminal of the first capacitor and a control terminal of the third switch; a control terminal of the second switch is coupling to a second control signal, an inputting terminal of the second switch is coupling to the data signal, an outputting terminal of the second switch is coupling to a second terminal of the first capacitor and a first terminal of the second capacitor; an inputting terminal of the third switch is coupling to a power source positive voltage, an outputting terminal of the third switch is coupling to a second terminal of the second capacitor and a first terminal of the light emitting element; a second terminal of the light emitting element is electrically connecting a power source negative voltage.

The pixel driving circuit of this present invention includes a first switch, a second switch and a third switch, a first capacitor and a second capacitor, and a light emitting element; a control terminal of the first switch is coupling to a first control signal, an inputting terminal of the first switch is coupling to a data signal, an outputting terminal of the first switch is coupling to a first terminal of the first capacitor and a control terminal of the third switch; a control terminal of the second switch is coupling to a second control signal, an inputting terminal of the second switch is coupling to the data signal, an outputting terminal of the second switch is coupling to a second terminal of the first capacitor and a first terminal of the second capacitor; an inputting terminal of the third switch is coupling to a power source positive voltage, an outputting terminal of the third switch is coupling to a second terminal of the second capacitor and a first terminal of the light emitting element; a second terminal of the light emitting element is electrically connecting a power source negative voltage. It could control the first switch and the second switch of pixel driving circuit of the present invention to switch on or switch off, and also using property the first capacitor and the second capacitor are coupled to each other for enhancing the actual driving voltage of light emitting element. Therefore, it could achieve to drive the light emitting element by inputting less driving voltage, and correspondingly enhance accuracy of actual driving voltage and reduce power consumption.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a circuit structural schematic view of a pixel driving circuit according to an embodiment of the disclosure;

FIG. 2 is a circuit structural schematic view of a pixel driving circuit according to another embodiment of the disclosure;

FIG. 3 is a signal timing diagram of a pixel driving circuit according to the embodiment of FIG. 2;

FIG. 4 is a flow chart of a driving method of a pixel driving circuit according to an embodiment of the disclosure; and

FIG. 5 is a structural schematic view of a display panel according to an embodiment of the disclosure.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

The disclosure will be further described in detail with reference to accompanying drawings and preferred embodiments as follows.

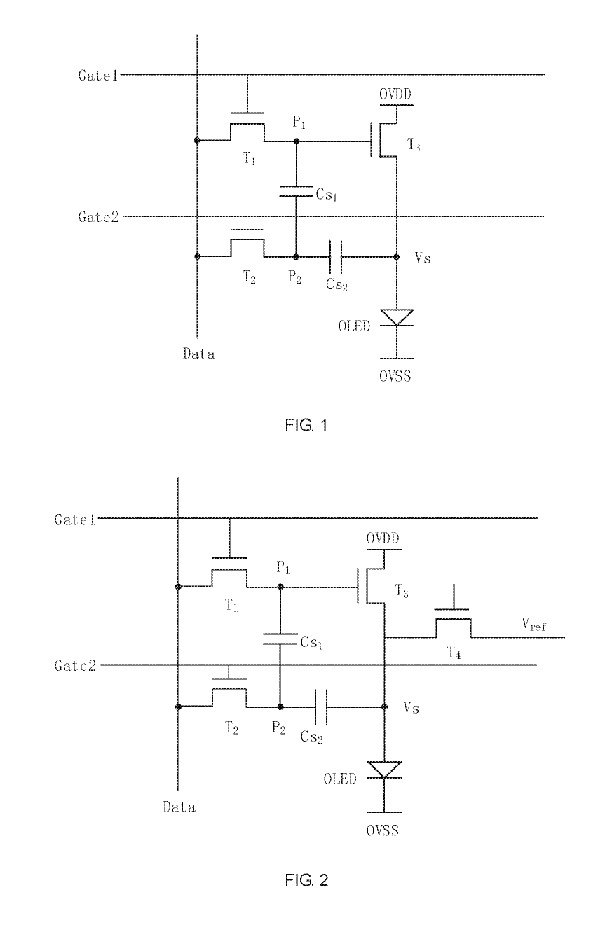

Please refer to FIG. 1. FIG. 1 is a circuit structural schematic view of a pixel driving circuit according to an embodiment of the disclosure. The pixel driving circuit comprising a first switch T₁, a first capacitor Cs₁, a second switch T₂, a second capacitor Cs₂, a third switch T₃ and a light emitting element OLED.

Wherein, a control terminal of the first switch T₁ is coupling to a first control signal G₁, which is connecting to a driving line Gate1; an inputting terminal of the first switch is coupling to a data signal V_{data}, which is connecting to a data line Data; an outputting terminal of the first switch is coupling to a first terminal of the first capacitor Cs₁ and a control terminal of the third switch T₃.

The control terminal of the second switch T₂ is coupling to a second control signal G₂ and connecting to a second driving line Gate2; an inputting terminal of the second switch is coupling to the data signal V_{data}, which connecting to the data line Data; an outputting terminal of the second switch is electrically connecting to a second terminal of the first capacitor Cs₁ and a first terminal of the second capacitor Cs₂.

The inputting terminal of the third switch T₃ is coupling to a power source positive voltage V_{DD}, an outputting terminal of the third switch is electrically connecting to a second terminal of the second capacitor Cs₂ and a first terminal of the light emitting element OLED.

The second terminal of the light emitting element OLED is electrically connecting a power source negative voltage Vₛₛ.

In this embodiment, according to control switch-on and switch-off for the first switch T₁ and the second switch T₂, and using the electrically coupled property of the first capacitor Cs₁ and the second capacitor Cs₂ to enhance actual driving voltage of the light emitting element OLED.

Specifically, control to switch on the first switch T₁ firstly and switch off the second switch T₂, voltage of P₁ is V_{data}, voltage of P₂ is

$$\frac{{C}_{s 1}}{{C}_{s 1} + {C}_{s 2}} {V}_{data} ;$$

and then control to switch off the first switch T₁ and switch on the second switch T₂, according to the property of coupled with the first capacitor Cs₁ and the second capacitor Cs₂, which will increases the voltage of P₁ to

$${V}_{data} + {V}_{data} - \frac{{Cs}_{1}}{{Cs}_{1} + {Cs}_{2}} {V}_{data} ;$$

at least control switch of first switch T₁ and switch off the second switch T₂, at this time, the OLED is lighting, and driving voltage is

$${V}_{data} + {V}_{data} - \frac{{Cs}_{1}}{{Cs}_{1} + {Cs}_{2}} {V}_{data} .$$

When the Cs₂ is larger than Cs₁, the actual driving voltage could be enhanced double. It also could control the actual driving voltage Vs according to ratio to Cs₂ and Cs₁. Based on these, the embodiment of driving circuit could actually enhance the actual driving voltage, and using less inputting driving voltage to achieve driving the light emitting element, and correspondingly enhance accuracy of the actual driving voltage and reduce power consumption.

Please refer to FIG. 2. FIG. 2 is a circuit structural schematic view of a pixel driving circuit according to another embodiment of the disclosure. The pixel driving circuit of this embodiment is similar to the embodiment of FIG. 1. Which includes a first switch T₁, a first capacitor Cs₁, a second switch T₂, a second capacitor Cs₂, a third switch T₃ and a light emitting element OLED. The connection of these elements are similar to the FIG. 1, here is not repeat again.

In this embodiment, the driving circuit further comprising a fourth switch T₄, a control terminal of the fourth switch is coupling to a reference control signal G₃, an inputting terminal of the fourth switch is connecting to a reference voltage V_{ref}, the reference voltage is a constant voltage. The outputting terminal of the fourth switch is electrically connecting to a second terminal of the second capacitor Cs₂.

In this embodiment, the first switch T₁, the second switch T₂, the third switch T₃ and the fourth switch T₄ are thin film transistors. The thin film transistors are low temperature poly-silicon thin film transistors, oxide semiconductor thin film transistors or amorphous silicon thin film transistors. In this embodiment using N type thin film transistors, each of N type thin film transistors includes grid, source and drain which are respectively corresponding to control terminal, inputting terminal and outputting terminal of switch. When voltage of grid is low potential, the source and drain of switch be switched off. When voltage of grid is high potential, the source and drain of switch be switched on.

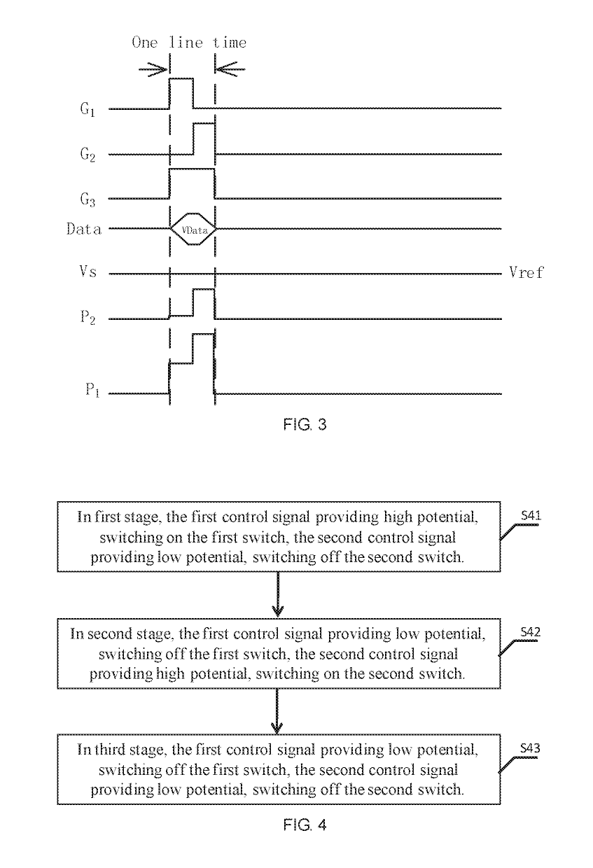

The specifically driving method of the driving circuit in this embodiment, please refer to FIG. 3, FIG. 3 is a signal timing diagram of a pixel driving circuit according to the embodiment of FIG. 2.

Wherein, data signal V_{data} is provided by the data line, the first control signal G₁ is provided by the first scan line Gate1, the second control signal G₂ is provided by the second scan line Gate2, the reference control signal G₃ is provided by a control line.

In a line time, inputting V_{data} signal, the reference control signal G₃ is high potential which keep switching on the third switch T₃, and the voltage of Vs is V_{ref}.

Firstly, the first control signal G₁ providing high potential, the second control signal G₁ providing low potential, correspondingly switching on the first switch T₁, switching off the second switch T₂. At this time, voltage of P₁ point is V_{data}, voltage of P₁ point is

$$\frac{{C}_{s 1}}{{C}_{s 1} + {C}_{s 2}} ( {V}_{data} - {V}_{data} ) .$$

And then, the first control signal G₁ providing low potential, the second control signal G₂ providing high potential, correspondingly switching off the first switch T₁, switching on the second switch T₂. At this time, voltage of P₁ point enhances to

$${V}_{data} + {V}_{data} - \frac{{C}_{s 1}}{{C}_{s 1} + {C}_{s 2}} ( {V}_{data} - {V}_{data} ) ..$$

After finish the line time, the first control signal G₁, the second control signal G₂, the reference control signal G₃ are low potentials, the correspondingly first switch T₁, the correspondingly second switch T₂ and the correspondingly second switch T₃ are switch off. At this time, the OLED is lighting, and driving voltage is

$${V}_{data} + {V}_{data} - \frac{{C}_{s 1}}{{C}_{s 2} + {C}_{s 2}} ( {V}_{data} - {V}_{data} ) - {V}_{ref} .$$

According to the driving circuit of this embodiment, when Cs₂=2Cs₁, if the inputting driving voltage is V_{data}=10V, the actual driving voltage be obtained is 15V; when Cs₂=1000 Cs₁, the inputting driving voltage is equal to 10V, and then the actual driving voltage be obtained to 19.99V.

According to the calculation above, in the final result, the most effectively reason of driving voltage is ratio to the first capacitor Cs1 and the second capacitor Cs2 be increased. Enhancing the ratio to the first capacitor Cs1 and the second capacitor Cs2 could substantially increase the actual driving voltage. At the same time, obtaining a certain value of driving voltage according to control the ratio to the first capacitor Cs1 and the second capacitor Cs2, reducing range of inputting driving voltage, increasing accuracy of actual driving voltage.

According to the driving circuit above, which is using two driving line for driving an OLED light. The specifically process please refer to FIG. 4. FIG. 4 is a flow chart of a driving method of a pixel driving circuit according to an embodiment of the disclosure. Wherein, the pixel driving circuit could refer to the circuit diagraph of FIG. 1 or FIG. 2, the driving method comprising:

S41: in first stage, the first control signal providing high potential, switching on the first switch, the second control signal providing low potential, switching off the second switch.

S42: in second stage, the first control signal providing low potential, switching off the first switch, the second control signal providing high potential, switching on the second switch.

S43: in third stage, the first control signal providing low potential, switching off the first switch, the second control signal providing low potential, switching off the second switch.

The three stages above is similar to the driving process of FIG. 2, here is not repeat again.

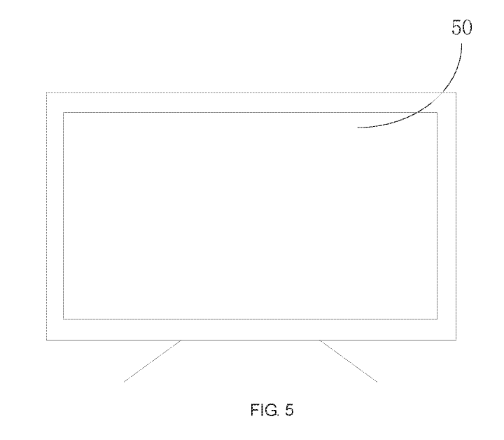

A display panel also be provided in this present invention, please refer to FIG. 5. FIG. 5 is a structural schematic view of a display panel according to an embodiment of the disclosure. The display panel 50 includes the pixel driving circuit described above, the pixel driving circuit could be the pixel driving circuit showing in FIG. 1 and FIG. 2, and using the driving method shown as FIG. 4.

The display panel of the embodiment includes the pixel driving circuit described above. The pixel driving circuit includes comprising a first switch, a second switch and a third switch, a first capacitor and a second capacitor, and a light emitting element; a control terminal of the first switch is coupling to a first control signal, an inputting terminal of the first switch is coupling to a data signal, an outputting terminal of the first switch is electrically connecting to a first terminal of the first capacitor and a control terminal of the third switch; a control terminal of the second switch is coupling to a second control signal, an inputting terminal of the second switch is electrically connecting to the data signal, an outputting terminal of the second switch is electrically connecting to a second terminal of the first capacitor and a first terminal of the second capacitor; an inputting terminal of the third switch is coupling to a power source positive voltage, an outputting terminal of the third switch is coupling to a second terminal of the second capacitor and a first terminal of the light emitting element; a second terminal of the light emitting element is electrically connecting a power source negative voltage. Using this driving circuit which could substantially increase driving voltage, reduce range of inputting voltage, enhance accuracy of voltage during the consistent voltage module situation. The display panel of this embodiment has lower power consumption, better display effect.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A driving method of pixel driving circuit, the pixel driving circuit comprising a first switch, a second switch and a third switch, a first capacitor and a second capacitor, and a light emitting element;
a control terminal of the first switch is coupling to a first control signal, an inputting terminal of the first switch is coupling to a data signal, an outputting terminal of the first switch is coupling to a first terminal of the first capacitor and a control terminal of the third switch;
a control terminal of the second switch is coupling to a second control signal, an inputting terminal of the second switch is coupling to the data signal, an outputting terminal of the second switch is coupling to a second terminal of the first capacitor and a first terminal of the second capacitor;
an inputting terminal of the third switch is coupling to a power source positive voltage, an outputting terminal of the third switch is coupling to a second terminal of the second capacitor and a first terminal of the light emitting element;
a second terminal of the light emitting element is electrically connecting a power source negative voltage;
the driving method comprising:
in a first stage, the first control signal providing high potential, switching on the first switch, the second control signal providing low potential, switching off the second switch;
in a second stage, the first control signal providing low potential, switching off the first switch, the second control signal providing high potential, switching on the second switch;
in a third stage, the first control signal providing low potential, switching off the first switch, the second control signal providing low potential, switching off the second switch.

2. The driving method of pixel driving circuit according to claim 1, wherein the pixel driving circuit further comprising a fourth switch, a control terminal of the fourth switch is coupling to a reference control signal, an inputting terminal of the fourth switch is coupling to a reference voltage, an outputting terminal of the fourth switch is connecting to a second terminal of the second capacitor;
the driving method further comprising:
in the first stage and the second stage, the reference control signal providing high potential, switching on the fourth switch;
in the third stage, the reference control signal providing low potential, switching off the fourth switch;

3. A pixel driving circuit, the driving circuit comprising a first switch, a second switch and a third switch, a first capacitor and a second capacitor, and a light emitting element;
a control terminal of the first switch is coupling to a first control signal, an inputting terminal of the first switch is coupling to a data signal, an outputting terminal of the first switch is coupling to a first terminal of the first capacitor and a control terminal of the third switch;
a control terminal of the second switch is coupling to a second control signal, an inputting terminal of the second switch is coupling to the data signal, an outputting terminal of the second switch is coupling to a second terminal of the first capacitor and a first terminal of the second capacitor;
an inputting terminal of the third switch is coupling to a power source positive voltage, an outputting terminal of the third switch is coupling to a second terminal of the second capacitor and a first terminal of the light emitting element;
a second terminal of the light emitting element is electrically connecting a power source negative voltage.

4. The pixel driving circuit according to claim 3, wherein the driving circuit further comprising a fourth switch;
a control terminal of the fourth switch is coupling to a reference control signal, an inputting terminal of the fourth switch is coupling to a reference voltage, an outputting terminal of the fourth switch is connecting to a second terminal of the second capacitor.

5. The pixel driving circuit according to claim 4, wherein the first switch, the second switch, the third switch and the fourth switch are thin film transistors; control terminals are grid, inputting terminals are source and outputting terminal are drain.

6. The pixel driving circuit according to claim 5, wherein the thin film transistors are low temperature poly-silicon thin film transistors, oxide semiconductor thin film transistors or amorphous silicon thin film transistors.

7. The pixel driving circuit according to claim 4, wherein the reference voltage is a constant voltage.

8. The pixel driving circuit according to claim 3, wherein capacitance of the first capacitor is less than capacitance of the second capacitor.

9. The pixel driving circuit according to claim 3, wherein the light emitting element is LED.

10. A display panel, wherein the display panel comprising a pixel driving circuit; the driving circuit comprising a first switch, a second switch and a third switch, a first capacitor and a second capacitor, and a light emitting element;
a control terminal of the first switch is coupling to a first control signal, an inputting terminal of the first switch is coupling* to a data signal, an outputting terminal of the first switch is coupling to a first terminal of the first capacitor and a control terminal of the third switch;
a control terminal of the second switch is coupling to a second control signal, an inputting terminal of the second switch is coupling to the data signal, an outputting terminal of the second switch is coupling to a second terminal of the first capacitor and a first terminal of the second capacitor;
an inputting terminal of the third switch is coupling to a power source positive voltage, an outputting terminal of the third switch is coupling to a second terminal of the second capacitor and a first terminal of the light emitting element;
a second terminal of the light emitting element is electrically connecting a power source negative voltage.

11. The display panel according to claim 10, wherein the driving circuit further comprising a fourth switch;
a control terminal of the fourth switch is coupling to a reference control signal, an inputting terminal of the fourth switch is coupling to a reference voltage, an outputting terminal of the fourth switch is connecting to a second terminal of the second capacitor.

12. The display panel according to claim 11, wherein the first switch, the second switch, the third switch and the fourth switch are thin film transistors; control terminals are grid, inputting terminals are source and outputting terminal are drain.

13. The display panel according to claim 12, wherein the thin film transistors are low temperature poly-silicon thin film transistors, oxide semiconductor thin film transistors or amorphous silicon thin film transistors.

14. The display panel according to claim 11, wherein the reference voltage is a constant voltage.

15. The display panel according to claim 10, wherein capacitance of the first capacitor is less than capacitance of the second capacitor.

16. The display panel according to claim 10, wherein the light emitting element is LED.
